(19) United States
(12) Patent Application Publication
(10) Pub. No.: US 2005/0237187 A1
(43) Pub. Date: Oct. 27, 2005

(54) Real-time security alert & connectivity system for real-time capable wireless cellphones and palm/hand-held wireless apparatus

(76) Inventor: Sharon Ann Hayes Martin, Los Angeles, CA (US)

Correspondence Address: SHARON ANN HAYES-MARTIN, 11574 SEMINOLE CIRCLE, NORTHRIDGE, CA, 91326, US

(21) Appl. No.: 10/821,761

(22) Filed: Apr. 9, 2004

(51) Int. Cl. G08B 13/00

(52) U.S. Cl. 340/541; 340/539.1

(57) ABSTRACT

Whenever unauthorized entry occurs, the invention's alert system module works with the user's installed security surveillance system, which, in turn, joins up with that security surveillance system while dailing the user on his/her real-time wireless cellular-type phone or palm-held device. Upon full execution of the call, the invention feds the user visual images, in real time, of activity inside or around their property with the ability for user to control security cameras, speakers and monitors in and/or around their property via their real-time wireless cellular-type phone or palm-held device.

### FIELD OF INVENTION

The scope of this invention involves the joining of two different technologies to facilitate real-time visual connectivity by way of user's homebased, computer-driven security surveillance system, in order to extend control of that system's surveillance to the user's real-time capable wireless/cellular phone or palm/hand-held device whenever unauthorized entry occurs.

### DESCRIPTION OF PRIOR ART

In a broader sense, real-time software products cover a wide spectrum of intricate designs developed for specific functionality. These designs vary since the complexity of this technology is still emerging, so the same does not afford a broad-use spectrum at this time. For several years, the real-time monitoring of certain homes, and businesses, has been facilitated by the implimentation of point-to-point circuitry. This functionality involves the main computer's security mechanism contacting another computer at different location, with a display of unauthorized entry in real-time. The enhanced security surveillance for the general public has been slow to none and the handling of home and business thief has changed, mostly to the detriment of potential thief victims, posturing the public to seek other means of protecting their own homes and businesses. Although hi-tech security systems are becoming more feasible, the notification method remains limited. The better security surveillance methods offer the user real-time viewing of their property. However, real-time remote-controlled viewing also has limitations, because the apparatus receiving the alert is either stationary or centralized, plus it has to be manned by someone at that stationary/centralized location(s).

Point-to-point security alert and surveillance capabilities have been proven to be a highly effective application, yet the need for someone to man the back-end system is a direct restriction of use. That is, someone has to be there to receive notification to observe unauthorized entry. It can be of great benefit for a homeowner with the financial means to pay an employee(s) to man such a system, but for the mass public it's not feasible.

Over the years, security firms have enhanced measures to track one's property—security patrol cars, surveillance notification via their database, etc. Still, unauthorized entry into a person's property is virtually over with before the property resident has knowledge it happened. Also, resent laws in some area no long require officers to investigate burglary alert signals, because of the drastic increase in user-error calls that waste their time. So the public is being forced into a posture of seeking new ways to protect their own homes and businesses while they're away.

### SUMMARY OF THE INVENTION

This devise is designed to provide immediate alert from the homebased computer, in real-time, to wireless cellphone or palm/hand-held apparatus with real-time viewing capabilities whenever unauthorized entry occurs. An embodiment of this invention is real-time viewing and security surveillance-system control that afford the user a more effective method of monitoring their own home or business. Another aspect of the invention is it's alert and control design that compliments newer version surveillance software applications by facilitating their connectivity and receptive maneuvering capabilities over, but not limited to, real-time wireless-based cellular or palm/hand-held devices. The invention's real-time design is unique in that it travel over Wi-Fi, seamless roaming and like-carrier type technologies that offer the capability to send and receive real-time visual data by way of hi-speed internet and/or satellite connections, which is an intricate part of the invention's activation/connectivity criteria. That is, the invention also facilitates the user's ability to remotely control their home/business security cameras, security speakers and security/television monitors via real-time cellular wireless gadgetry. This can occur generally from wherever they can receive the call signal, as is the case with cellular devices on the market today.

The main function of the software is to work in conjunction with the homebased computerized security surveillance system to alert the user should unauthorized entry occur, then provide that user with immediate real-time viewing, tracking and communication capabilities over aforementioned real-time cellular wireless gadgetry. This method of connectivity is designed to work in conjunction with hi-tech security surveillance software. The invention drives the security surveillance system to perform in a totally different mode while, at the same time, extending the mobile user real-time control over viewing, tracking and communication by way of his/her real-time capable wireless cellular and palm/hand-hand device. That is, the source computerized security surveillance system sends a signal designed to be read by the invention, immediately engaging the invention which, in turn, prompts the call mechanism to the user's real-time capable, wireless-based cellular/palm-held device. When the call is answered, a line is established between the home computer's security surveillance system, giving the owner remote control of their homebased computer's security surveillance system by way of the invention's real-time visual and control capabilities.

With real-time connectivity via real-time cellular wireless technology, partnered with a computerized surveillance system, the user can track an intruder by way of key-commands they themselves have set-up in the invention's control module. For example, key number “3” on the wireless real-time cellular device activates security camera “3” at the home or business, offering a real-time view of the intruder in the room where “Camera 3” is located. Another feature of the invention is that is allows the homeowner to activate voice control to inform intruder(s) that he/she is being watched and recorded. The user also has the option to prompt the home computer to send the intruder(s) image to a centralized security database, should that function be a part of the homebased computer's security surveillance system. That is, the current functionality of the invention is limited to the functionality of the homebased computerized security surveillance system. This is further exampled below.

Other objects of the invention will appear hereinafter that further outlines the capabilities and use.

Accordingly, the invention comprises of a vital component designed to enhance hi-tech security surveillance systems that are exemplified in the following disclosure, the scope of which will be indicated in the appended claims.

A fuller understanding of the nature of the present invention may be deemed apparent upon consideration of the following depictions in connection with accompanying drawings:

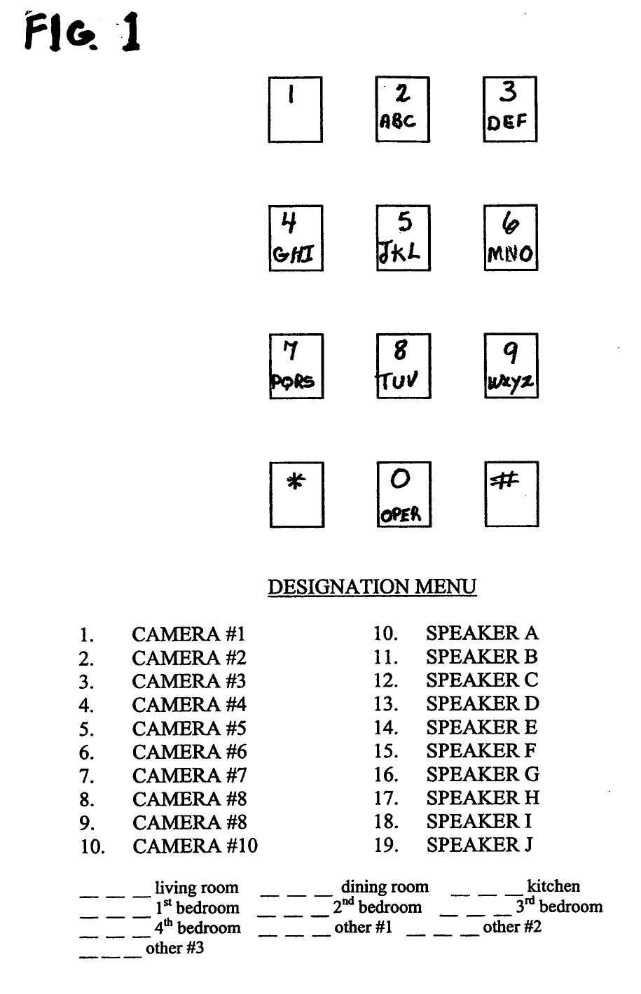

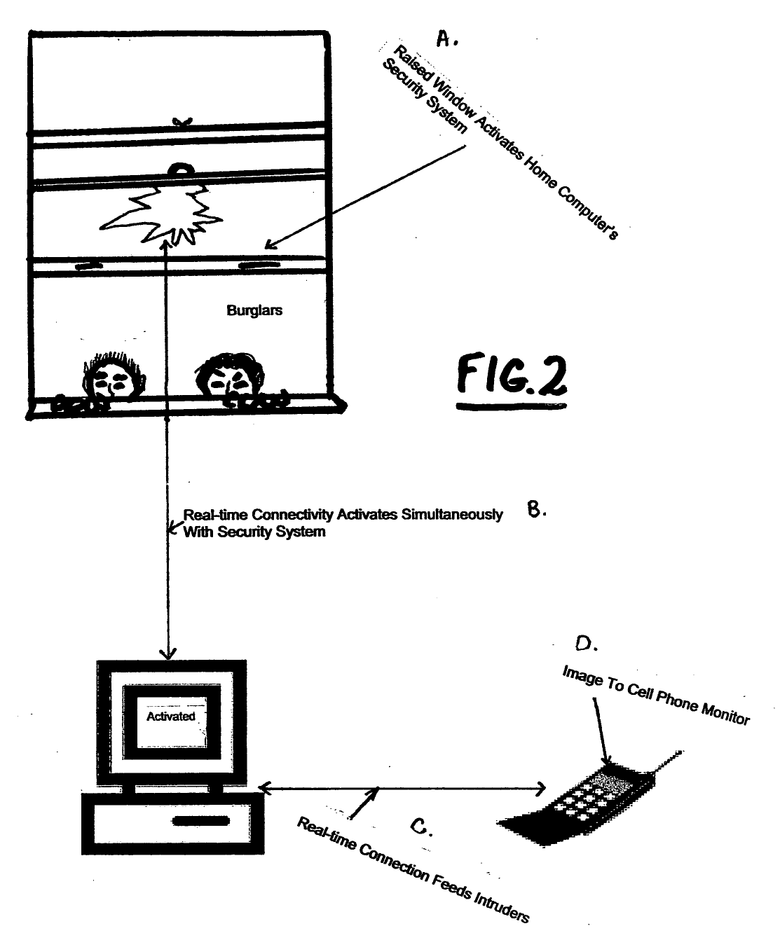

FIG. 1 shows unauthorized entry initiating an alert.

FIG. 2 is the working of the invention as related to the method of connectivity between the homebased computer and a real-time capable wireless cellular device.

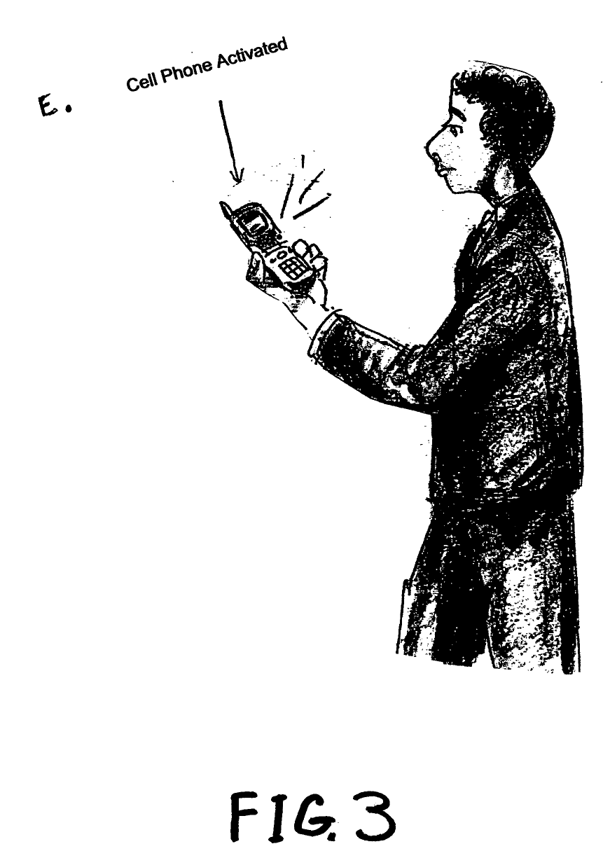

FIG. 3 is the execution of an alert to a hand-held, real-time wireless device.

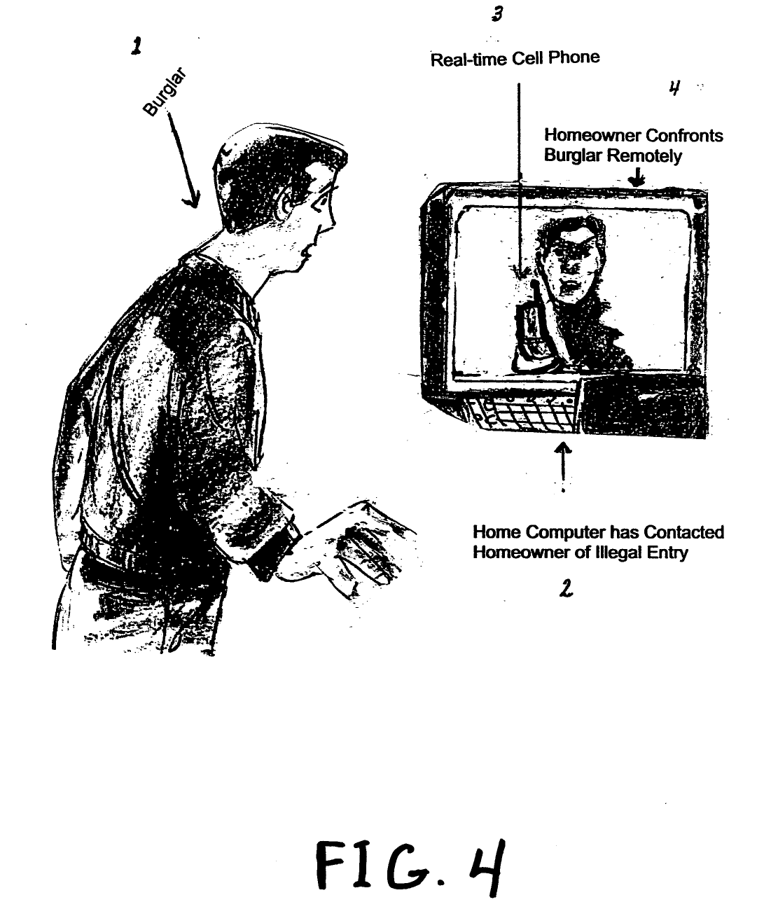

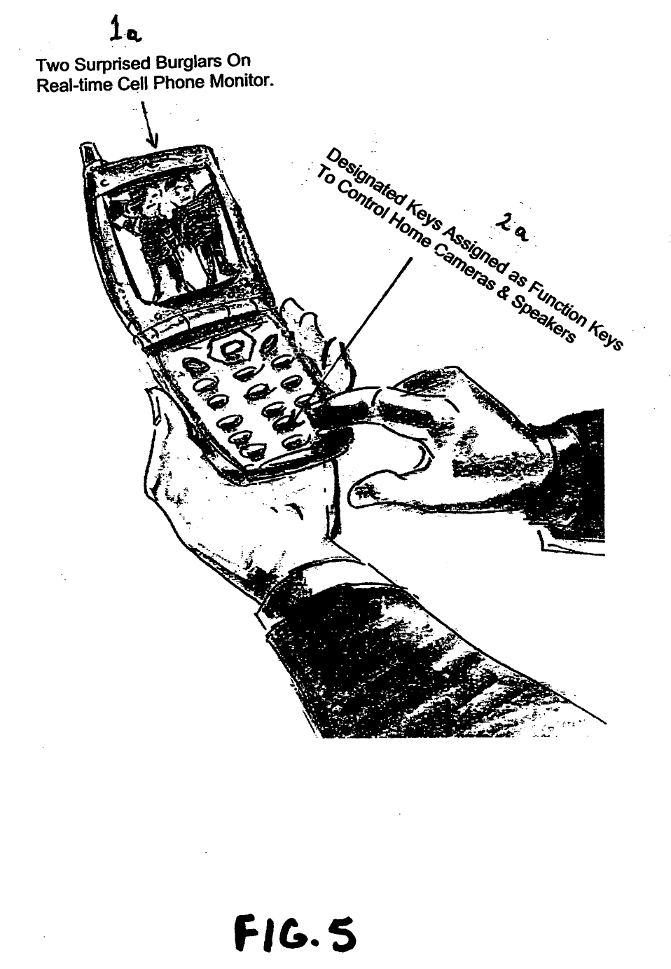

FIG. 4 shows how unauthorized entry has fully engaged the user's real-time hand-held device.

To sum up FIG. 1 through 4, unauthorized entry inside the home alerts the homebased computer security system, which, in turn, triggers the invention's dial mechanism. Upon full execution of the call, the invention establishes the connection between user's computerized security surveillance system and his/her real-time cellular device, giving user tracking, voice and view control via the hand-held device.

The invention is designed with built-in security measures. A seven-digit password is required to change or modify user's programmed settings. The binary-coded design of the invention affords the user easy command input capabilities. Also, the invention's default commands can be changed to the user's desired activation commands.

Connectivity between the homebased computer and the real-time wireless cellular and/or palm held-held device afford users control over their homebased computer's security surveillance system. He/she will have specific operational abilities over that system via their visual real-time cellular or palm/hand-held device. That is, the real-time wireless device acts like a command center, giving the user visual-command control over their home-surveillance system once the connection is made. This is accomplished by the binary command string that permits the user to press selected keys to initiate specific, remote-capable commands. For example, the user may choose the number “3” to tell his/her computerized security surveillance system to activate “Camera 3”, allowing them to track the intruder's penetration into another area of the house or business over their real-time visual wireless hand-held device. Another key can be selected to activate speakers, if speaker capability is a feature of the user's homebased computer surveillance system.

Control commands that are a part of the invention's settings module are limited to the user's computer-based security surveillance system. That is because the invention is designed to join one technology with a more enhanced technology, the latter being real-time visual surveillance capabilities over real-time capable wireless cellular-type phones and palm-held devices, to give user operational control of their homebased, computerized surveillance system while away.

To expound on the aforementioned limitations, if the user only has three surveillance cameras throughout a six room house that are a part of the security surveillance program installed on the homebased computer, the invention can only project real-time visuals offered by any of those three cameras since the invention draws its data from the activated computerized surveillance system.

The invention works with a specific carrier-type technology to establish connectivity between the computerized surveillance system and real-time visual wireless/palm-held devices. Currently available are Wi-Fi, seamless roaming and their equivalent links. These real-time internet and/or satellite-driven links facilitate the invention's high-speed connectivity between digital internet/satellite and digital LAN-computers, achieving real-time security alert and surveillance of one's home or business via real-time visual wireless cellular-type and palm/hand-held apparatus.

The range of the invention's use and adaptability is based the demands of the user and/or security surveillance entities. That is, the design can either be incorporated into computerized security surveillance programs by way a license agreement or installed independently to work with user's existing or purchased computerized security surveillance system.

Since certain enhancements may be made in the foregoing disclosure without departing from the scope of the invention herein outlined, it is intended that all matters contained in the above description and depicted in the accompanying drawings be construed in an illustrative and not in a limiting perspective.

1. can offer the user greater security surveillance control over their home or business should unauthorized entry occur.

2. will alert the user on their real-time wireless-based cellular type phone or palm-held device of unauthorized entry.

3. binary-coded commands are designed with alert, real-time connectivity and remote control capabilities.

4. the invention allows designated keys on the real-time wireless-based cellular type phone/palm-held devices to be used to track intruder(s), store intruder(s) image, send recorded image(s) to their contracted security firm's database, if any, and provide voice communication between the home/business over user's real-time wireless cellular-type or phone/palm-held device.

5. user has the option to watch the intruder's activity via tracking commands they have keyed into the invention's command module, record the intruder throughout the duration of their unauthorized entry inside the home or business and/or communicate with the intruder by pressing keys designated for voice activation.

6. computerized surveillance system is the actual security mechanism that triggers the invention when the computerized surveillance system itself is triggered. Once triggered the systems are paired, giving user control of his/her homebased security surveillance system via their real-time wireless cellular-type phone or palm-held device.

7. a visual inside the home/business is displayed with tracking capabilities from the real-time wireless cellular-type phone/palm-held device.

8. the binary-coded design works with the users computerized security system by way of an alert, visual, tracking and communication control design that are unique to the invention.

9. the invention's functions are limited to the computerized security system's capabilities to a greater or lesser degree. That is, if the computerized security has ten cameras throughout the home or business, with voice activation and monitors, the user has the ability to control these capabilities from their real-time wireless cellular-type phone or palm-held device while mobile.

10. a seven-digit password is required to change or modify user's programmed settings. The binary-coded design of the invention affords the user easy set-up and command capabilities.

11. an aspect of the invention is to facilitate connectivity by way of Wi-Fi, seamless roaming and similar technologies that provide high-speed visual imaging over internet, LAN or via satellite links to he user's real-time wireless cellular-type phone or palm-held device by way of the designated phone number entered into the invention's contact module.

12. the design can either be incorporated into computerized security surveillance programs by way a license agreement, or installed independently to work with user's existing or purchased computerized security surveillance system.
